(19) United States
(12) Patent Application Publication
(10) Pub. No.: US 2010/0083104 A1
(43) Pub. Date: Apr. 1, 2010

(54) ELECTRONIC APPARATUS WITH DICTIONARY FUNCTION

(75) Inventor: Katsushi Hirano, Akishima-shi (JP)

Correspondence Address: TUROCY & WATSON, LLP, 127 Public Square, 57th Floor, Key Tower, CLEVELAND, OH, 44114, US

(73) Assignee: CASIO COMPUTER CO., LTD., Tokyo (JP)

(21) Appl. No.: 12/564,140

(22) Filed: Sep. 22, 2009

(30) Foreign Application Priority Data
Sep. 26, 2008 (JP) 2008-249155

(51) Int. Cl. G06F 17/21; G06F 17/30; G06F 17/25; G06F 17/20; G06F 17/22; G06F 17/24; G06F 17/26; G06F 17/27; G06F 17/28

(52) U.S. Cl. 715/259; 715/823; 715/829

(57) ABSTRACT

When the up-down pagefeed key is pressed in a state where each entry word read from the dictionary is sorted in a specific character order (in alphabetic order or in order of the Japanese syllabary) according to the corresponding language and displayed as an entry word list in the entry word list mode, the entry word above or below the current entry word is set as the selected entry word by the up-down cursor key, and the cursor is displayed on the n-th letter in the selected entry word, the first entry word above or below the current entry word differing in the n-th letter on which the cursor is located is set as a newly selected entry word and the cursor is displayed on the new n-th letter. When the translation/decision key is pressed, explanatory information on the selected entry word is read from the dictionary and displayed.

### CROSS-REFERENCE TO RELATED APPLICATIONS

This application is based upon and claims the benefit of priority from prior Japanese Patent Application No. 2008-249155, filed Sep. 26, 2008, the entire contents of which are incorporated herein by reference.

### BACKGROUND OF THE INVENTION

1. Field of the Invention

This invention relates to an electronic apparatus which includes a plurality of dictionary contents and has a dictionary function and to a computer-readable recording medium which stores a series of processing procedures for a program that can be executed by a computer system.

2. Description of the Related Art

Generally, an electronic dictionary apparatus has a keyboard where hiragana character and alphabetic letter input keys are arranged. To search for a desired entry word, the user inputs the reading of a character string of an entry word to be searched for from the character input keys. An entry word coinciding with the input character string to be searched for is retrieved and displayed. When the user presses the decision key, explanatory information on the retrieved entry word is read and displayed.

Such a conventional electronic dictionary apparatus has the following problems: (1) pressing the character input keys caused to correspond to the reading of the character string of an entry word to be searched for is laborious; (2) some user is unable to use the keyboard where character input keys have been arranged; and (3) the body of the apparatus cannot help becoming larger because a keyboard must be provided.

To overcome these problems, an electronic dictionary has been considered which enables the user to touch a desired range of indexes of the entry words arranged in order of the Japanese syllabary or in alphabetic order with a pen (e.g., refer to Jpn. Pat. Appin. KOKAI Publication No. 07-230463).

However, although the conventional electronic dictionary configured to enable the user to touch the index of an entry word with a pen to display an entry word list needs no keyboard and therefore needs no troublesome key pressing, a device which recognizes a pen touch must be provided.

### BRIEF SUMMARY OF THE INVENTION

According to an aspect of the invention, there is provided an electronic apparatus with a dictionary function comprising: dictionary storage means for storing a plurality of entry words arranged in a specific character order and items of dictionary information corresponding to the individual entry words so as to cause the former to correspond to the latter; selection means for selecting an arbitrary entry word stored in the dictionary storage means by pressing a first direction indicator key; highlighting means for specifying an arbitrary character in an entry word selected by the selection means and highlighting the arbitrary character by pressing a second direction indicator key; reselection means for, when a third direction indicator key is input, reading from the dictionary storage means a first entry word where the character in the position corresponding to the character highlighted at that time in the direction indicated by the third direction indicator key differs from the highlighted character and reselecting the first entry word; and dictionary display means for reading the selected entry word and dictionary information corresponding to the entry word from the dictionary storage means and displaying the selected entry word and dictionary information.

According to another aspect of the invention, there is provided a computer-readable recording medium which includes a series of instruction groups for a program executable on a computer system, the program including: an instruction group which causes a storage unit to store a plurality of entry words arranged in a specific character order and items of dictionary information corresponding to the individual entry words so as to cause the former to correspond to the latter; an instruction group which causes an arbitrary entry word stored in the storage unit to be selected by pressing a first direction indicator key; an instruction group which Causes an arbitrary character in the selected entry word to be specified and highlighted on a display unit by pressing a second direction indicator key; an instruction group which, when a third direction indicator key is pressed, causes a first entry word where the character in the position corresponding to the character highlighted at that time in the direction indicated by the third direction indicator key differs from the highlighted character to be read from the storage unit and reselected; and an instruction group which causes the selected entry word and dictionary information corresponding to the entry word to be read from the storage unit and displayed on the display unit.

According to still another aspect of the invention, there is provided an electronic apparatus with a dictionary function comprising: a user interface which has a first to a third direction indicator key; a display unit; a memory which stores a plurality of entry words arranged in a specific character order and items of dictionary information corresponding to the individual entry words so as to cause the former to correspond to the latter; and a processor which selects an arbitrary entry word stored in the dictionary storage means by pressing a first direction indicator key, specifies an arbitrary character in the selected entry word and highlights the arbitrary character on the display unit by pressing a second direction indicator key; when a third direction indicator key is input, reads from the memory a first entry word where the character in the position corresponding to the character highlighted at that time in the direction indicated by the third direction indicator key differs from the highlighted character and reselects the first entry word; and reads the selected entry word and dictionary information corresponding to the entry word from the memory and displays the selected entry word and dictionary information on the display unit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of the electronic circuitry of an electronic dictionary apparatus 10 according to an embodiment of an electronic apparatus with a dictionary function of the invention;

FIG. 2 is a flowchart to explain a dictionary search process (part 1) of the electronic dictionary apparatus 10;

FIG. 3 is a flowchart to explain a dictionary search process (part 2) of the electronic dictionary apparatus 10;

FIG. 4 is a flowchart to explain a dictionary search process (part 3) of the electronic dictionary apparatus 10; and

FIG. 5 is a diagram to explain a display state of an entry word search according to user operation in the dictionary search process of the electronic dictionary apparatus 10.

### DETAILED DESCRIPTION OF THE INVENTION

Embodiments according to the present invention will be described in detail with reference to the accompanying drawings. The scope of the claimed invention should not be limited to the examples illustrated in the drawings and those described in below.

Hereinafter, an embodiment of the invention will be explained with reference to the accompanying drawings.

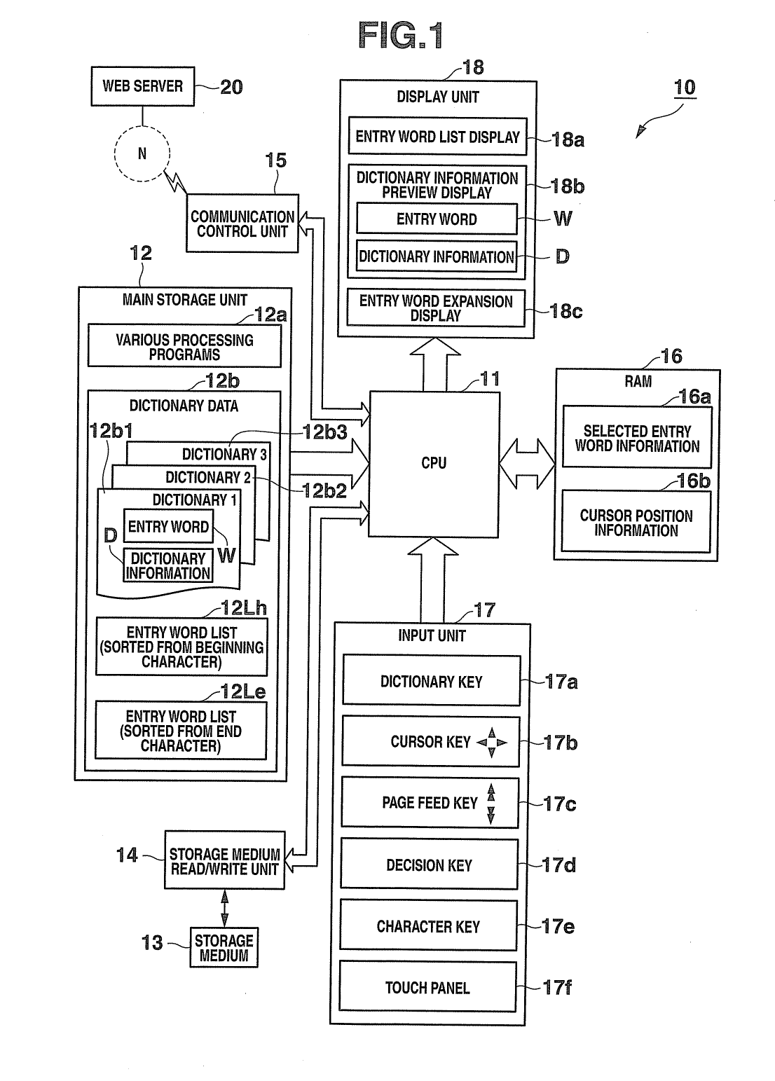

FIG. 1 is a block diagram showing the configuration of the electronic circuitry of an electronic dictionary apparatus 10 according to an embodiment of an electronic apparatus with a dictionary function of the invention.

The electronic apparatus with a dictionary function is configured as a portable device for an electronic dictionary (or an electronic dictionary apparatus 10) explained below or as a personal digital assistant (PDA), a personal computer (PC), a mobile phone, an electronic book, a portable game device, or the like.

The electronic dictionary apparatus 10 is composed of a computer that reads in programs recorded in various types of recording mediums or transmitted programs and is controlled on the basis of the read-in programs. The electronic circuitry is provided with a central processing unit (CPU) 11.

Using a RAM 16 as a working memory, the CPU 11 controls the operation of each circuit according to an apparatus control program previously stored in a main storage unit (flash memory) 12, an apparatus control program read from an external storage medium 13, such as a ROM card, into the main storage unit 12 via a storage medium write/read unit 14, or an apparatus control program read from a Web server (in this case, a program server) 20 on the Internet N into the main storage unit 12 via a communication control unit 15.

The apparatus control program stored in the main storage unit 12 is activated according to an input signal corresponding to user operation from an input unit 17, a communication signal from each Web server 20 on the Internet connected via the communication control unit 15, or a connection communication signal to a memory card (storage medium) 13, such as an EEPROM, a RAM, or a ROM, externally connected via the storage medium read/write unit 14.

Connected to the CPU 11 are the main storage unit 12, storage medium read/write unit 14, communication control unit 15, RAM 16, input unit 17, a display unit 18, and others.

The main storage unit 12 stores an apparatus control program including a system program that supervises the operation of all of the electronic dictionary apparatus 10 and a communication program for communicating data with each Web server 20 or a user personal computer (PC) (not shown) on the Internet via the communication control unit 15. The main storage unit 12 further stores various processing programs 12a for controlling search processes in general on the basis of a dictionary database 12b stored in the main storage unit 12, including the process of selecting the mode of searching for an entry word according to the key input of a search character string (an entry word search mode) or the mode of searching an entry word list for an entry word according to a cursor key input (an entry word list mode) and searching for the entry word and the process of reading and displaying various items of explanatory information, including the translation, semantic content, and example sentence (example) corresponding to the selected entry word.

A plurality of types of dictionary contents 12b1, 12b2, . . . the dictionary database 12b has include, for example, a Japanese-language dictionary, an English-Japanese dictionary, a Japanese-English dictionary, a kabji dictionary, a four-character phrase dictionary, and an encyclopedia. Different types of dictionary data have been stored beforehand or are downloaded and stored.

Each of the dictionary contents 12b1, 12b2, . . . has entry words W arranged in a specific order according to the corresponding language and explanatory information D including the translations, semantic contents, and example sentences (examples) of the entry words W.

An entry word list (sorted from the beginning character) 12Lh the dictionary database 12b has is obtained by sorting all of the entry words W from the beginning character in a specific character order (e.g., in order of the Japanese syllabary or in alphabetic order) for each of the dictionary contents 12b1, 12b2, . . . . An entry word list (sorted from the end character) 12Le is obtained by sorting all of the entry words W from the end character in a specific character order for each of the dictionary contents 12b1, 12b2, . . . .

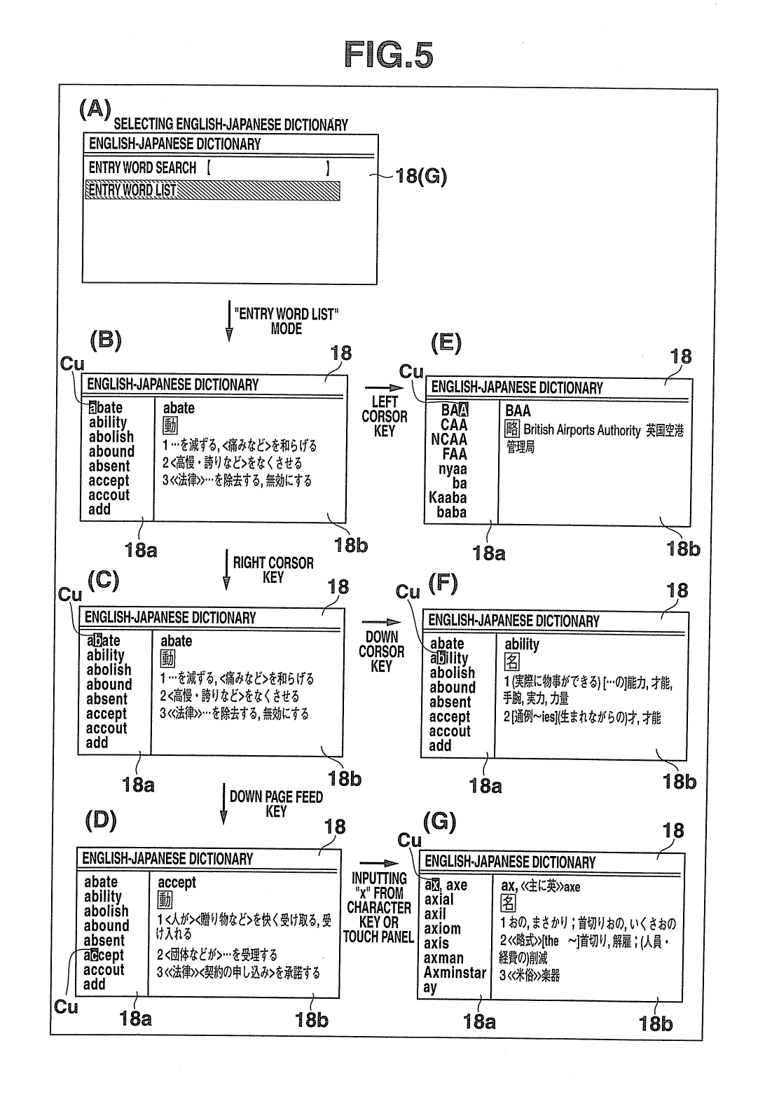

The RAM 16 has a storage area for display data corresponding to the display screen of the display unit 18. The RAM 16 includes a display memory in which the data to be displayed on the display screen is expanded as bitmap pattern data and stored, an input character memory in which input data, such as characters, numbers, or symbols, input by the user from the input unit 17 according to the various processing programs 12a is stored, a search result memory in which entry words subjected to a dictionary search process and explanatory information are stored, a work memory in which various items of data input to or output from the CPU 11 according to the various processing programs 12a are stored as needed, a selected entry word information memory 16a in which an entry word currently selected by the entry word search process is stored, and a cursor position information memory 16b where in what number of the order of the letters of (or on an n-th letter of) the currently selected entry word stored in the selected entry word information memory 16a the cursor Cu (see FIG. 5) is located, counting from the beginning letter, is stored.

The input unit 17 includes a dictionary key 17a, a cursor key 17b, a pagefeed key 17c, a translation/decision key 17d, a character input key 17e, and a touch panel 17f.

In the dictionary search process, the display unit 18 provides an entry word list display 18a, a dictionary information preview display 18b that previews the selected entry word W in the entry word list display 18a and its dictionary information D, and an entry word expansion display 18c that expands explanatory information on the selected entry word over the full screen.

Next, the dictionary search function mainly based on pressing cursor keys on the electronic dictionary apparatus 10 will be explained.

When a menu key on the input unit 17 is pressed, a dictionary selection screen for selecting a target dictionary from the dictionary contents 12b1, 12b2, . . . stored in the dictionary database 12b is displayed on the display unit 18 (step S1).

On the dictionary selection screen, if a target dictionary (e.g. English-Japanese dictionary) is selected by pressing the cursor key 17b (or the target dictionary is selected directly by pressing the dictionary key 17a) (YES in step S2), as shown in FIG. 5(A), an entry word search method selection screen G for selecting either a search method in an “entry word search mode” in which a desired entry word is searched for according to the key input of a search character string or a search method in an “entry word list mode” in which a desired entry word is searched for according to the input of the cursor key 17b from an entry word list is displayed on the display unit 18 (step S3).

On the entry word search method selection screen G, if it has been determined that the “entry word list mode” has been selected by user operation (YES in step S4), the entry words sorted from the beginning character in a specific character order (e.g., in alphabetic order in the case of an English dictionary or in order of the Japanese syllabary in the case of a Japanese-language dictionary) according to the language of the dictionary selected as a search target as shown in FIG. 5(B) are read from the entry word list (sorted from the beginning character) 12Lh in the dictionary database 12 and displayed on the display unit 18 as an entry word list display 18a with the beginning character position (place) aligned. In this case, in the initial state of the entry word list display 18a, the first entry word “abate” is set as the selected entry word and the cursor Cu is displayed on the beginning letter “a.” In what number of the order of letters (on an n-th letter) of the entry word the cursor Cu is located with the beginning letter of the selected entry word as a first letter is stored and managed at the cursor position information memory 16b of the RAM 16 (step S5).

As shown in FIG. 5(B), the display unit 18 provides not only the entry word list display 18a but also shows the selected entry word “abate” where the cursor Cu is located and its explanatory information as a dictionary information preview display 18b.

On the entry word list display 18a shown in

FIG. 5(B), if the right cursor key [→] (17b) has been pressed (YES in step S6), it is determined whether there is any letter to the right of the letter “a” where the cursor is now located (step S7).

If it has been determined that there is the letter “b” to the right of the letter “a” where the cursor is currently located (YES in step S7), the cursor Cu is moved to the left-hand letter “b” as shown in FIG. 5(C) (step S8).

On the entry word list display 18a of FIG. 5(B), for example, if the right cursor key [→] (17b) has been pressed in a state where the cursor Cu is located on the end letter “e” of the selected entry word “abate” (n=5) (YES in step S6), it is determined that there is no letter to the right of the letter “e” where the cursor Cu is located (NO in step S7). In this case, of the entry words existing below the selected entry word “abate,” the first entry word “ability” where there is an (n+1)th ((=5+1)th) letter is set as a newly selected entry word. The cursor Cu is displayed on the (n+1)th (=6th) letter “t” in the selected entry word “ability” (step S9).

As shown in FIG. 5(C), on the entry word list display 18a where the cursor Cu has been moved to the second letter “b” in the selected entry word “abate,” if the down pagefeed key [↓] (17c) has been pressed (YES in step S17), the first entry word “accept” whose n-th (second) letter (“c” in this case) differs from the letter “b” where the cursor Cu is located among the entry words in the down direction specified by the pagefeed key 17c with respect to the selected entry word “abate” as shown in FIG. 5(D) is set as a newly selected entry word. The cursor Cu is displayed on the n-th letter “c” in the newly selected entry word “accept” (step S18).

Similarly, if the up pagefeed key [↑] (17c) has been pressed (YES in step S17), the first entry word whose n-th letter differs from the letter where the cursor Cu is located among the entry words in the up direction specified by the pagefeed key 17c with respect to the selected entry word is set as a newly selected entry word. The cursor Cu is displayed on the n-th letter in the newly selected entry word (step S18).

Furthermore, as shown in FIG. 5(C), on the entry word list display 18a where the cursor Cu has been moved to the second letter “b” in the selected entry word “abate,” if the down cursor key [↓] (17b) has been pressed (YES in step S15), the next entry word “ability” existing in the down direction specified by the cursor key 17b with respect to the selected entry word “abate” as shown in FIG. 5(F) is set as a newly selected entry word. The cursor Cu is displayed on the n-th (second) letter “b” in the newly selected entry word (step S16).

In contrast, as shown in FIG. 5(F), on the entry word list display 18a where the cursor Cu has been moved to the second letter “b” in the selected entry word “ability,” if the up cursor key [↑] (17b) has been pressed (YES in step S15), the next entry word “abate” existing in the up direction specified by the cursor key 17b with respect to the selected entry word “ability” as shown in FIG. 5(C) is set as a newly selected entry word. The cursor Cu is displayed on the n-th (second) letter “b” in the newly selected entry word (step S16).

Moreover, as shown in FIG. 5(C), on the entry word list display 18a where the cursor Cu has been moved to the second letter “b” in the selected entry word “abate,” if the left cursor key [←] (17b) has been pressed (YES in step S10), it is determined whether there is any letter to the left of the letter “b” where the cursor Cu is now located (step S11).

If it has been determined that the letter “a” is to the left of the letter “b” where the cursor Cu is now located (YES in step S11), the cursor Cu is moved and displayed on the left-hand letter “a” as shown in FIG. 5(B) (step S12).

Furthermore, as shown in FIG. 5(B), on the entry word list display 18a where the cursor Cu is located on the beginning letter “a” in the selected entry word “abate,” if the left cursor key [←] (17b) has been pressed (YES in step S10), it is determined that there is no letter to the left of the letter “a” where the cursor Cu is located (NO in step S11). In this case, as shown in FIG. 5(E), the entry words sorted from the end letter in a specific letter order are read from the entry word list (sorted from the end letter) 12Le in the dictionary database 12 and are displayed on the display unit 18 in the form of an entry word list display 18a “BAA,” “CAA,” “NCAA,” . . . in reverse search form with the end letter positions (places) aligned. In this case, since the position n of the cursor Cu stored and managed at the cursor position information memory 16b is stored and managed in such a manner that the left and right letters are interchanged and the end letter in the selected entry word is set as the first letter, the end letter “A” in the selected entry word “BAA” is set as the first letter where the cursor Cu is displayed (step S13).

As shown in FIG. 5(E), on the entry word list display 18a where the cursor Cu is located on the end letter “A” in the selected entry word “BAA” whose right and left letters have been interchanged in reverse search, if the right cursor [→] (17b) has been pressed, interchanging the right and left letters results in YES in step S10 and NO in step S11. That is, it has been determined that there is no letter to the right of the letter “A” where the cursor Cu is located. Then, in the state where the right and left letters have been interchanged, as shown in FIG. 5(B), the entry words sorted from the beginning letter in the specific letter order are read from the entry word list (sorted from the beginning letter) 12Lh in the dictionary database 12 and are displayed on the display unit 18 in the form of a normal entry word list display 18a “abate,” “ability,” “abolish,” . . . with the beginning letter positions (places) aligned (step S13). In this case, since the position n of the cursor Cu stored and managed at the cursor position information memory 16b is stored and managed in such a manner that the beginning letter in the selected entry word is set as the first letter as a result of the cancellation of the interchange of the left and right letters in reverse search, the beginning letter “a” in the selected entry word “abate” is set as the first letter where the cursor Cu is displayed.

In addition, as shown in FIGS. 5(C) to 5(D), even in a state where the first entry word below or above the current entry word where the cursor Cu is located on a letter different from the one on which the cursor was located is searched for as a newly selected entry word in a skip search according to the pressing of the pagefeed key 17c (step S17→S18), if the letter where the cursor Cu is located must be skipped significantly, for example, from “c” to “x,” a desired letter “x” is directly input by pressing the character key 17e on the input unit 17 or manually writing on the touch panel 17f in a state where the cursor Cu is displayed on the n-th letter in the present selected entry word differing from that in the desired entry word (YES in step S19).

Then, as shown in FIG. 5(G), the top entry word “ax, axe” where the letters up to the (n-1)th (first) are the same as in the present selected entry word and the n-th (second) letter is the directly-input letter “x” are set as newly selected entry words and the cursor Cu is displayed on the n-th letter “x” (step S20).

As described above, by directly inputting the desired letter using the letter key 17a or touch panel 17f, an entry word search process using the cursor key 17b and pagefeed key 17c on an as-needed basis can be carried out quickly. Moreover, using the touch panel 17f enables kanji characters or Korean characters which require a plurality of key inputs from the character key 17e to be input easily.

Thereafter, in a state where the desired entry word has been retrieved and set as a selected entry word according to the entry word search process in steps S1 to S20, if the translation/decision key 17d is pressed (YES in step S21), explanatory information on the selected entry word is read from the dictionary data 12bn to be searched for and expanded as an entry word expansion display 18c on the full screen of the display unit 18 (step S22).

Accordingly, with the dictionary search function mainly based on pressing the cursor keys of the electronic dictionary apparatus 10, when the up-down pagefeed key 17c is pressed in a state where each entry word read from the dictionary data 12bn to be searched for is sorted in a specific character order (in alphabetic order or in order of the Japanese syllabary) according to the corresponding language and displayed as an entry word list display 18a in the entry word list mode, the entry word above or below the current entry word is set as the selected entry word by the up-down cursor key 17b, and the cursor Cu is displayed on the n-th letter in the selected entry word by the right-left cursor key 17b, the first entry word above or below the current entry word differing in the n-th letter on which the cursor Cu is located is set as a newly selected entry word and the cursor Cu is displayed on the new n-th letter. In a state where the selected entry word is set with the cursor Cu displayed on the desired entry word, if the translation/decision key 17d is pressed, explanatory information on the selected entry word is read from the dictionary data 12bn and displayed as an entry word expansion display 18c on the display unit 18. Therefore, by just pressing the cursor key 17b and pagefeed key 17c in combination, it is possible to select a desired entry word very easily and retrieve and display its dictionary information.

Furthermore, with the dictionary search function mainly based on pressing the cursor keys of the electronic dictionary apparatus 10, if letters are input from the character key 17e or letters are input by manually writing on the touch panel 17f in a state where the dictionary search process is carried out in the entry word list mode, an entry word obtained by directly replacing the letter on which the cursor Cu is located with the input letter in the present selected entry word is set as a newly selected entry word and the cursor Cu is displayed on the newly set entry word. Accordingly, when the desired entry word is widely separated in a specific letter order from the selected entry word highlighted with the cursor Cu, selected entry words can be skipped at a stretch close to the desired entry word.

Moreover, in a state where the cursor Cu is displayed on the leftmost beginning letter in the selected entry word, if the left cursor key 17b has been pressed, the entry words sorted from the end letter in a specific letter order are displayed as an entry word list display 18a in reverse search on the display unit 18 and the entry word list 18a in the normal state is searched for the entry word with the right and left cursor keys 17b interchanged. Therefore, by just pressing the cursor key 17b and pagefeed key 17c in combination, the desired entry word can be selected quickly in various forms and its dictionary information is retrieved and displayed.

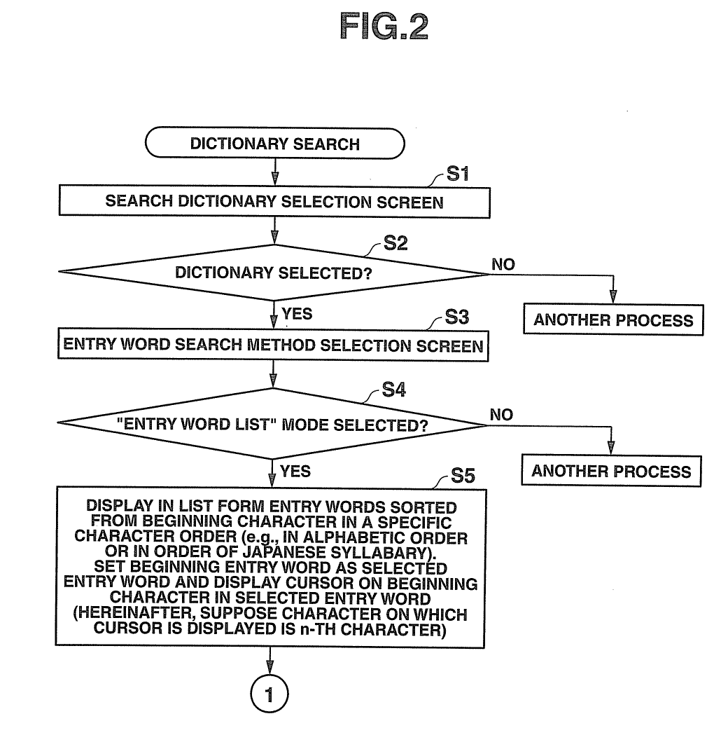

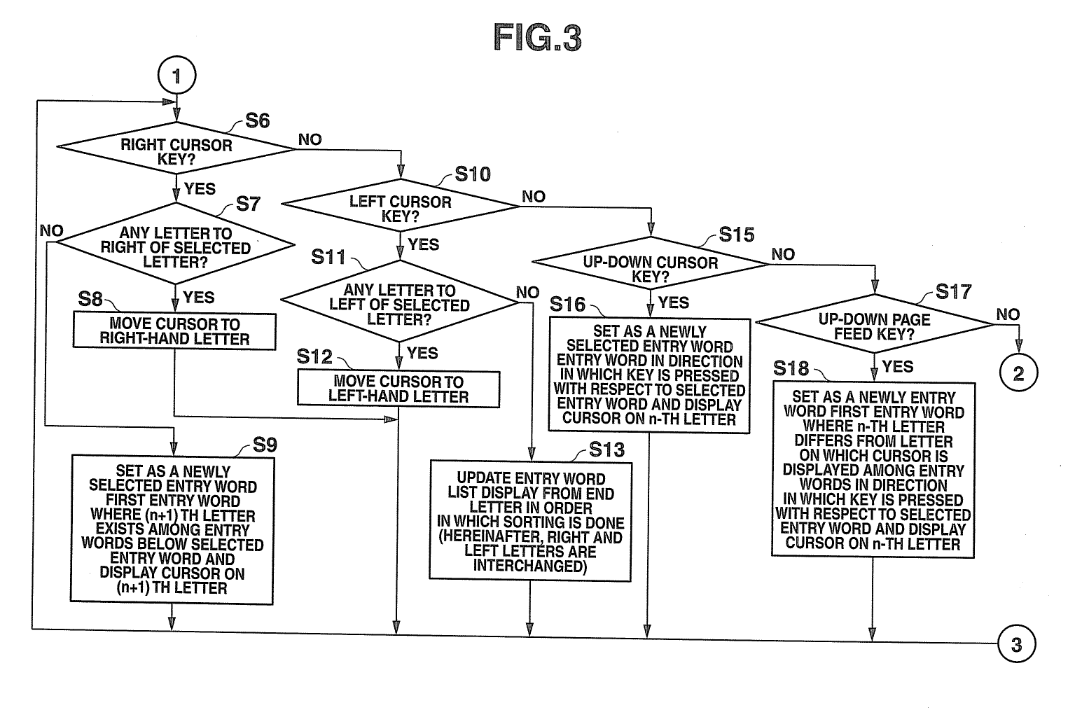

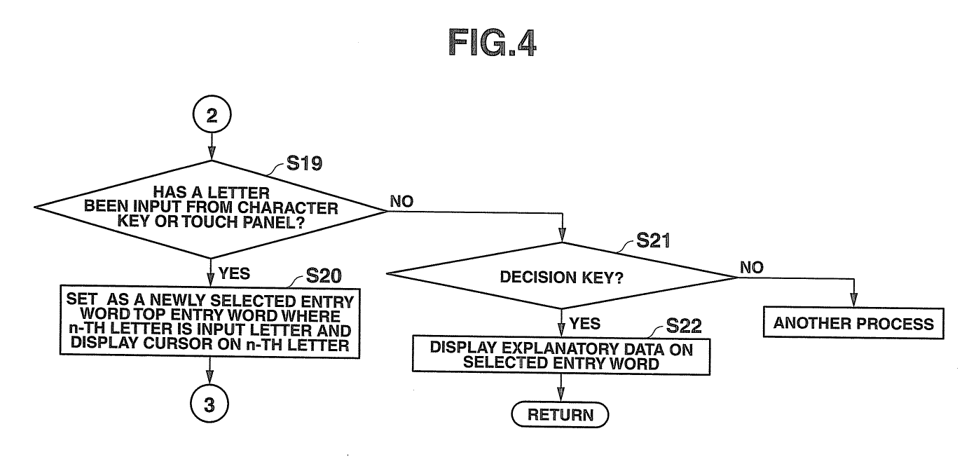

The methods of the individual processes in the electronic dictionary apparatus 10 written in the embodiment, including the methods of the dictionary search processes (part 1) to (part 3) shown in the flowcharts of FIGS. 2 to 4, can be stored in an external storage medium 13, such as a memory card (e.g., a ROM card or a RAM card), a magnetic disk (e.g., a floppy disk or a hard disk), an optical disk (e.g., a CD-ROM or a DVD), or a semiconductor memory, in the form of programs the computer can execute. Then, the medium can be delivered. The computer of the electronic apparatus 10 with the dictionary database 12b loads the program stored in the external storage medium 13 into the storage unit 12. The computer is controlled by the read-in program, thereby realizing the dictionary search function mainly based on the cursor operation explained in the embodiment, which enables the same processes in the aforementioned methods to be carried out.

Furthermore, the data of the programs which realize the above methods can be transferred in the form of program code through a network N. The program data is loaded into the computer of the electronic apparatus 10 with the dictionary database 12b connected to the network N via the communication control unit 15, thereby realizing the dictionary search function mainly based on pressing the cursor keys.

It is to be understood that the present invention is not limited to the specific embodiments described above and that the invention can be embodied with the components modified without departing from the spirit and scope of the invention. The invention can be embodied in various forms according to the appropriate combinations of the components disclosed in the embodiments described above. For example, some components may be deleted from all components shown in the embodiments. Further, the components in different embodiments may be used appropriately in combination.

What is claimed is:

1. An electronic apparatus with a dictionary function comprising:
dictionary storage which stores a plurality of entry words arranged in a specific character order and items of dictionary information corresponding to the individual entry words so as to cause the former to correspond to the latter;
selection means for selecting an arbitrary entry word stored in the dictionary storage by pressing a first direction indicator key;
highlighting means for specifying an arbitrary character in an entry word selected by the selection means and highlighting the arbitrary character by pressing a second direction indicator key;
reselection means for, when a third direction indicator key is input, reading from the dictionary storage a first entry word where the character in the position corresponding to the character highlighted at that time in the direction indicated by the third direction indicator key differs from the highlighted character and reselecting the first entry word; and
dictionary display means for reading the selected entry word and dictionary information corresponding to the entry word from the dictionary storage and displaying the selected entry word and dictionary information.

2. The electronic apparatus according to claim 1, further comprising: list display means for reading a specific number of entry words including the selected entry word from the dictionary storage and displaying the read-out entry words in list form.

3. The electronic apparatus according to claim 2, further comprising:
character input means for inputting a character according to user operation; and
second reselection means for, when a character is input by the character input means, reading from the dictionary storage an entry word where the characters up to the position corresponding to the character highlighted at that time coincide with the characters up to the character highlighted in the selected entry word and the character in the position corresponding to the highlighted character is the character input by the character input means and reselecting the read-out entry word.

4. The electronic apparatus according to claim 3, further comprising:
a reverse search list storage which stores said plurality of entry words in a specific character order, beginning with the end character toward the beginning character; and
highlight moving means for, when, the beginning character in an entry word selected by the selection means is highlighted, moving the highlighted character to the end character in the entry word if the left direction is specified by the second direction indicator key,
wherein the list display means, when the highlight moving means moves the highlight to the end character in the entry word, reads a specific number of entry words including the selected entry word from the reverse search list storage and displays the read-out entry words in list form.

5. The electronic apparatus according to claim 4, wherein the specific character order is alphabetic order or the order of the Japanese syllabary.

6. The electronic apparatus according to claim 3, wherein the specific character order is alphabetic order or the order of the Japanese syllabary.

7. The electronic apparatus according to claim 2, further comprising:
a reverse search list storage which stores said plurality of entry words in a specific character order, beginning with the end character toward the beginning character; and
highlight moving means for, when the beginning character in an entry word selected by the selection means is highlighted, moving the highlighted character to the end character in the entry word if the left direction is specified by the second direction indicator key,
wherein the list display means, when the highlight moving means moves the highlight to the end character in the entry word, reads a specific number of entry words including the selected entry word from the reverse search list storage and displays the read-out entry words in list form.

8. The electronic apparatus according to claim 2, wherein the specific character order is alphabetic order or the order of the Japanese syllabary.

9. The electronic apparatus according to claim 1, further comprising:
character input means for inputting a character according to user operation; and
second reselection means for, when a character is input by the character input means, reading from the dictionary storage an entry word where the characters up to the position corresponding to the character highlighted at that time coincide with the characters up to the character highlighted in the selected entry word and the character in the position corresponding to the highlighted character is the character input by the character input means and reselecting the read-out entry word.

10. The electronic apparatus according to claim 9, further comprising:
a reverse search list storage which stores said plurality of entry words in a specific character order, beginning with the end character toward the beginning character; and
highlight moving means for, when the beginning character in an entry word selected by the selection means is highlighted, moving the highlighted character to the end character in the entry word if the left direction is specified by the second direction indicator key,
wherein the list display means, when the highlight moving means moves the highlight to the end character in the entry word, reads a specific number of entry words including the selected entry word from the reverse search list storage and displays the read-out entry words in list form.

11. The electronic apparatus according to claim 10, wherein the specific character order is alphabetic order or the order of the Japanese syllabary.

12. The electronic apparatus according to claim 9, wherein the specific character order is alphabetic order or the order of the Japanese syllabary.

13. The electronic apparatus according to claim 1, wherein the specific character order is alphabetic order or the order of the Japanese syllabary.

14. A computer-readable recording medium which includes a series of instruction groups for a program executable on a computer system, the program including:
an instruction group which causes a storage unit to store a plurality of entry words arranged in a specific character order and items of dictionary information corresponding to the individual entry words so as to cause the former to correspond to the latter;
an instruction group which causes an arbitrary entry word stored in the storage unit to be selected by pressing a first direction indicator key;
an instruction group which causes an arbitrary character in the selected entry word to be specified and highlighted on a display unit by pressing a second direction indicator key;
an instruction group which, when a third direction indicator key is pressed, causes a first entry word where the character in the position corresponding to the character highlighted at that time in the direction indicated by the third direction indicator key differs from the highlighted character to be read from the storage unit and reselected; and
an instruction group which causes the selected entry word and dictionary information corresponding to the entry word to be read from the storage unit and displayed on the display unit.

15. The computer-readable recording medium according to claim 14, wherein the program further includes:
an instruction group which causes a character to be input according to user operation; and
an instruction group which, when a character is input, causes an entry word where the characters up to the position corresponding to the character highlighted at that time coincide with the characters up to the character highlighted in the selected entry word and the character in the position corresponding to the highlighted character is the character input by the character input means to be read from the storage unit and reselected.

16. An electronic apparatus with a dictionary function comprising:
a user interface which has a first to a third direction indicator key;
a display unit;
a memory which stores a plurality of entry words arranged in a specific character order and items of dictionary information corresponding to the individual entry words so as to cause the former to correspond to the latter; and
a processor which selects an arbitrary entry word stored in the memory by pressing a first direction indicator key,
specifies an arbitrary character in the selected entry word and highlights the arbitrary character on the display unit by pressing a second direction indicator key;
when a third direction indicator key is input, reads from the memory a first entry word where the character in the position corresponding to the character highlighted at that time in the direction indicated by the third direction indicator key differs from the highlighted character and reselects the first entry word; and
reads the selected entry word and dictionary information corresponding to the entry word from the memory and displays the selected entry word and dictionary information on the display unit.
